(19) United States
(12) Patent Application Publication
(10) Pub. No.: US 2021/0344066 A1
(43) Pub. Date: Nov. 4, 2021

(54) LITHIUM AIR BATTERY

(71) Applicant: Panasonic Intellectual Property Management Co., Ltd., Osaka (JP)

(72) Inventor: MASAKO YOKOYAMA, Osaka (JP)

(21) Appl. No.: 17/378,767

(22) Filed: Jul. 19, 2021

Related U.S. Application Data
(63) Continuation of application No. PCT/JP2019/051325, filed on Dec. 26, 2019.

(30) Foreign Application Priority Data
May 30, 2019 (JP) 2019-101767

(51) Int. Cl. H01M 12/08; H01M 4/133; H01M 4/1393; H01M 4/583; H01M 4/86; H01M 4/96; H01M 4/62

(52) U.S. Cl. CPC H01M 12/08; H01M 4/133; H01M 4/1393; H01M 2004/027; H01M 4/8605; H01M 4/96; H01M 4/623; H01M 4/583

(57) ABSTRACT

A lithium air battery includes a negative electrode, a positive electrode, and an electrolyte. The electrolyte contains a compound represented by the following formula. In this formula, R₁, R₂, and R₃ each independently represent a fluorinated alkyl group having 1 to 5 carbon atoms.

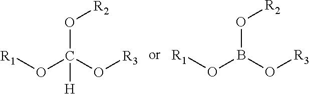

### BACKGROUND

### 1. Technical Field

The present disclosure relates to a lithium air battery.

### 2. Description of the Related Art

A lithium air battery is a battery in which oxygen in air is used as a positive electrode active material, and a metal or a compound capable of occluding and releasing lithium ions is used as a negative electrode active material. The lithium air battery has advantages such that the energy density is high, and the size and the weight thereof are likely to be reduced. Hence, the lithium air battery has drawn attention as a battery having an energy density higher than that of a lithium ion battery which is believed to have the highest energy density at the moment.

Olivia Wijaya et al., A gamma fluorinated ether as an additive for enhanced oxygen activity in Li—O2 batteries, J. Mater. Chem. A, 2015, 3, 19061-19067 (Non-Patent Document 1) has reported that a discharge capacity of a lithium air battery is increased by addition of 1,1,1,2,2,3,3,4,4-nonafluoro-6-propoxyhexane to an electrolyte liquid using tetraglyme as a solvent.

### SUMMARY

One non-limiting and exemplary embodiment provides a technique to increase a discharge capacity of a lithium air battery.

In one general aspect, the techniques disclosed here feature a lithium air battery comprising: a negative electrode including a negative electrode collector and a negative electrode layer on the negative electrode collector, the negative electrode layer being made of lithium metal; a positive electrode including an electrically conductive porous body containing carbon; and an electrolyte provided between the negative electrode and the positive electrode, the electrolyte containing a compound represented by the following formula (1) or formula (2).

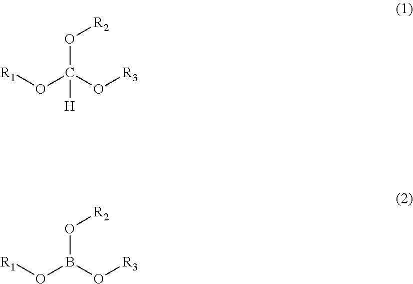

In the formula (1) or the formula (2), R₁, R₂, and R₃ each independently represent a fluorinated alkyl group having 1 to 5 carbon atoms.

According to the present disclosure, the discharge capacity of the lithium air battery can be increased.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic cross-sectional view of a lithium air battery according to one embodiment of the present disclosure;

FIG. 2 is a graph showing discharge curves of lithium air batteries of Examples and Comparative Examples; and

FIG. 3 is a graph showing the changes in redox current with time obtained by an atmosphere switching potentiostatic test using nonaqueous electrolyte liquids of Examples and Comparative Examples.

### DETAILED DESCRIPTION

### Underlying Knowledge Forming Basis of the Present Disclosure

In a lithium air battery, by a discharge reaction, oxygen is reduced on a surface of a positive electrode, and oxygen radicals are generated. Since oxygen to be used for the reaction is dissolved oxygen in a nonaqueous electrolyte liquid, when a solubility of oxygen in the nonaqueous electrolyte liquid and a dissolution rate of oxygen in the nonaqueous electrolyte liquid are low, a supply of oxygen to the surface of the positive electrode determines the rate of the discharge reaction. When the solubility of oxygen in the nonaqueous electrolyte liquid and the dissolution rate of oxygen in the nonaqueous electrolyte liquid are improved, a discharge capacity of the lithium air battery is believed to be increased.

Non-Patent Document 1 has disclosed that the solubility of oxygen in the nonaqueous electrolyte liquid and the dissolution rate of oxygen in the nonaqueous electrolyte liquid are improved by 1,1,1,2,2,3,3,4,4-nonafluoro-6-propoxyhexane.

However, through intensive research carried out by the present inventors, the effect obtained by 1,1,1,2,2,3,3,4,4-nonafluoro-6-propoxyhexane has not been always sufficient. In view of the solubility of oxygen in the nonaqueous electrolyte liquid and the dissolution rate of oxygen in the nonaqueous electrolyte liquid, the lithium air battery is still required to be improved.

### Guideline of Aspects of the Present Disclosure

A lithium air battery according to a first aspect of the present disclosure comprising:

a negative electrode including a negative electrode collector and a negative electrode layer on the negative electrode collector, the negative electrode layer being made of lithium metal;

a positive electrode including an electrically conductive porous body containing carbon; and

an electrolyte provided between the negative electrode and the positive electrode, the electrolyte containing a compound represented by the following formula (1) or formula (2).

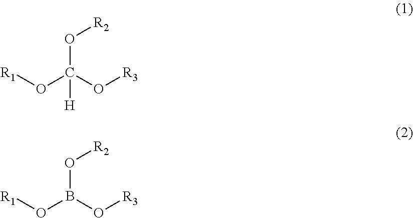

In the formula (1) or the formula (2), R₁, R₂, and R₃ each independently represent a fluorinated alkyl group having 1 to 5 carbon atoms.

The lithium air battery according to the first aspect has a high discharge capacity.

According to a second aspect of the present disclosure, for example, in the lithium air battery according to the first aspect, the compound described above may includes at least one selected from the group consisting of tris(2,2,2-trifloroethyl)borate and tris(2,2,2-trifluoroethyl)orthoformate. Since the molecular weights of those compounds are not excessively large, the compounds described above each have a sufficient compatibility with a nonaqueous solvent.

According to a third aspect of the present disclosure, for example, in the lithium air battery according to the first or the second aspect, the electrolyte may contain an ether. The ether has an excellent oxygen radical resistance. Hence, the ether is suitable as a solvent of the nonaqueous electrolyte liquid of the lithium air battery.

According to a fourth aspect of the present disclosure, for example, in the lithium air battery according to the third aspect, the ether may include a chain ether. Since being not likely to be vaporized and, in particular, being stable against oxygen radicals, the chain ether is suitable as the solvent of the electrolyte liquid of the lithium air battery.

According to a fifth aspect of the present disclosure, for example, in the lithium air battery according to the fourth aspect, the chain ether may include a glyme. When the glyme is used as the solvent of the electrolyte liquid, decomposition of the electrolyte liquid can be not only suppressed, but an increase in resistance of the lithium air battery can also be suppressed.

According to a sixth aspect of the present disclosure, for example, in the lithium air battery according to the fifth aspect, the glyme may include at least one selected from the group consisting of triglyme and tetraglyme. By using triglyme and/or tetraglyme as the solvent, while liquid shortage of the lithium air battery is prevented, transport of lithium ions and oxygen can be smoothly performed, and the discharge capacity can be increased.

Hereinafter, embodiments of the present disclosure will be described with reference to the drawings. The present disclosure is not limited to the following embodiments.

### EMBODIMENTS

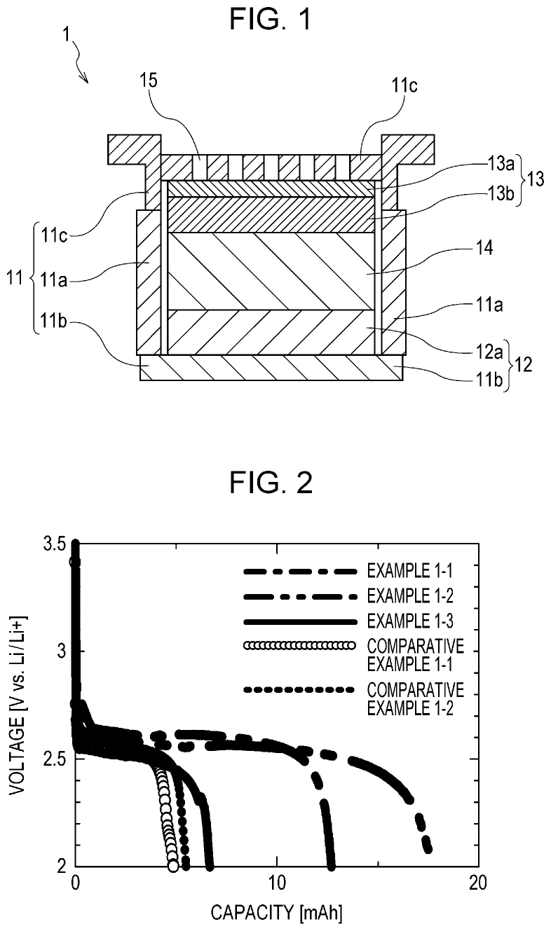

FIG. 1 is a schematic cross-sectional view of a lithium air battery according to one embodiment of the present disclosure. As shown in FIG. 1, a lithium air battery 1 of this embodiment includes a battery case 11, a negative electrode 12, a positive electrode 13, and an electrolyte layer 14 functioning as a nonaqueous lithium ion conductor. The battery case 11 has a cylindrical portion 11a in which a top surface side and a bottom surface side are both opened, a bottom portion 11b provided so as to close the bottom surface side opening of the cylindrical portion 11a, and a lid portion 11c provided so as to close the top surface side opening of the cylindrical portion 11a. In the lid portion 11c, air inlet holes 15 through which air is introduced into the battery case 11 are provided. The negative electrode 12 has a negative electrode layer 12a disposed on an inner bottom surface of the bottom portion 11b of the battery case 11. The bottom portion 11b of the battery case 11 also functions as a negative electrode collector of the negative electrode 12. That is, by the bottom portion 11b also functioning as the negative electrode collector and the negative electrode layer 12a, the negative electrode 12 is formed. The positive electrode 13 is formed of a positive electrode layer 13a containing a carbon material and a positive electrode collector 13b disposed between the positive electrode layer 13a and the lid portion 11c of the battery case 11.

The electrolyte layer 14 of the lithium air battery 1 may contain a separator. Besides the bottom portion 11b, another negative electrode collector may also be provided. The air battery 1 may further include a solid electrolyte contained in the electrolyte layer 14. The air battery 1 may further include a negative electrode protective film contained in the electrolyte layer 14 or the negative electrode layer 12a. The air battery 1 may further include an oxygen permeable film disposed at an upper part of the lid portion 11c of the battery case 11 or between the lid portion 11c and the positive electrode collector 13b.

Battery reactions in the lithium air battery 1 having the structure as described above are as follows.

Discharge reaction (that is, reaction when the lithium air battery 1 is used)

negative electrode: 2Li→2Li⁺+2e⁻ (A1)

positive electrode: 2Li⁺+2e⁻+O²→2Li₂O₂ (A2)

Charge reaction (that is, reaction when the lithium air battery 1 is charged)

negative electrode: 2Li⁺+2e⁻→2Li (A3)

positive electrode: Li₂O₂→2Li⁺+2e⁻+O₂ (A4)

In the discharge, as shown in the formulas (A1) and (A2), electrons and lithium ions are released from the negative electrode 12. At the same time when electrons are incorporated in the positive electrode 13, at the positive electrode 13, lithium ions and oxygen incorporated from the outside of the lithium air battery 1 react with each other to generate a lithium oxide. In the charge, as shown in the formulas (A3) and (A4), electrons and lithium ions are incorporated in the negative electrode 12. From the positive electrode 13, electrons, lithium ions, and oxygen are released.

Next, the constituent elements of the lithium air battery 1 as described above will be described in detail.

### 1. Positive Electrode

As described above, the positive electrode 13 contains the positive electrode layer 13a and may further contain the positive electrode collector 13b. Hereafter, the positive electrode layer 13a and the positive electrode collector 13b are respectively described.

### (Positive Electrode Layer)

The positive electrode layer 13a contains a material which enables oxygen in air to be oxidized and reduced as a positive electrode active material. As the material described above, the positive electrode layer 13a of this embodiment contains an electrically conductive porous body containing carbon. A carbon material to be used as the electrically conductive porous body containing carbon may have a high electron conductivity. In particular, a carbon material, such as acetylene black or Ketjen black, which is generally used as an electrically conductive auxiliary agent may be used. In view of the specific surface area and the size of primary particles, an electrically conductive carbon black, such as Ketjen black, may be used. The carbon material is generally in the form of a powder. The specific surface area of the carbon material is, for example, 800 m²/g or more and 2,000 m²/g or less and may also be 1,200 m²/g or more and 1,600 m²/g or less. When the specific surface area of the carbon material is in the range described above, a positive electrode layer 13a having a porous structure is likely to be formed. The specific surface area is a value measured by a BET method.

The positive electrode 13a may further contain a binder which fixes the electrically conductive porous body described above. As the binder of the positive electrode layer 13a of the lithium air battery 1, a material known as the binder may be used. As the binder, for example, a vinylidene fluoride (PVdF) or a polytetrafluoroethylene (PTFE) may be mentioned. A content of the binder in the positive electrode layer 13a is not particularly limited and is, for example, in the range of 1 percent by mass or more and 40 percent by mass or less.

Since being changed, for example, in accordance with the application of the lithium air battery 1, a thickness of the positive electrode layer 13a is not particularly limited. The thickness of the positive electrode layer 13a is, for example, in the range of 2 μm or more and 500 μm or less and may also be in the range of 5 μm or more and 300 μm or less.

The positive electrode layer 13a may be formed, for example, by the following method. A carbon material and a solvent are mixed together to prepare a mixture. If needed, an additive, such as a binder, may also be contained in the mixture. The mixture thus obtained (to be used as a coating liquid) is applied on the positive electrode collector 13b by a coating method, such as a doctor blade method, and a coating film thus obtained is dried. Accordingly, the positive electrode 13 is obtained. A sheet-shaped positive electrode layer 13a having no positive electrode collector 13b may also be formed such that after the coating film of the mixture is dried, the coating film thus dried is rolled by a method, such as a roll press. The carbon material may also be directly molded by a compression press so as to form a sheet-shaped positive electrode layer 13a.

### (Positive Electrode Collector)

The positive electrode collector 13b is a member to perform current collection from the positive electrode layer 13a. A material of the positive electrode collector 13b is not particularly limited as long as having an electrical conductivity. As the material of the positive electrode collector 13b, for example, stainless steel, nickel, aluminum, iron, titanium, or carbon may be mentioned. As the shape of the positive electrode collector 13b, for example, a foil shape, a plate shape, or a mesh (such as grid) shape may be mentioned. In this embodiment, the shape of the positive electrode collector 13b may be a mesh shape. The reason for this is that a mesh-shaped positive electrode collector 13b is excellent in current collection efficiency. In this case, in the positive electrode layer 13a, the mesh-shaped positive electrode collector 13b can be disposed. The lithium air battery 1 of this embodiment may further contain another positive electrode collector 13b (such as a foil-shaped collector) which collects charges collected by the mesh-shaped positive electrode collector 13b. In this embodiment, the battery case 11 which will be described later may also function as the positive electrode collector 13b. The thickness of the positive electrode collector 13b is, for example, in the range of 10 μm or more and 1,000 μm or less and may also be in the range of 20 μm or more and 400 μm or less.

### 2. Negative Electrode

As described above, the negative electrode 12 contains the negative electrode collector and may also further contain the negative electrode layer 12a. Hereinafter, the negative electrode layer 12a and the negative electrode collector will be respectively described.

### (Negative Electrode Layer)

The negative electrode layer 12a of this embodiment may contain a negative electrode active material. As the negative electrode active material described above, for example, metal lithium which is a metal element may be used.

The negative electrode layer 12a may contain only the negative electrode active material and may also contain a binder besides the negative electrode active material. When the negative electrode active material has a foil shape, the negative electrode layer 12a may contain only the negative electrode active material. When the negative electrode active material has a powder shape, the negative electrode layer 12a may contain the negative electrode active material and the binder. As the binder of the negative electrode layer 12a of the lithium air battery 1, a material known as the binder may be used, and for example, a PVdF or a PTFE may be mentioned. A content of the binder in the negative electrode layer 12a is not particularly limited and may be, for example, in the range of 1 percent by mass or more and 40 percent by mass or less. As a method to form the negative electrode layer 12a using a powdered negative electrode active material, as is the case of the method for forming the positive electrode layer 13a described above, a doctor blade method or a formation method by a compression press may be used.

### (Negative Electrode Collector)

The negative electrode collector is a member to perform current collection from the negative electrode layer 12a. A material of the negative electrode collector is not particularly limited as long as having an electrical conductivity. As the material of the negative electrode collector of the lithium air battery 1, for example, a known material may be used. As the material of the negative electrode collector, for example, copper, stainless steel, nickel, or carbon may be mentioned. As the shape of the negative electrode collector, for example, a foil shape, a plate shape, or a mesh (such as grid) shape may be mentioned. The negative electrode collector may be a porous body having an irregular surface. The battery case 11 which will be described later may also function as the negative electrode collector.

### 3. Separator

The lithium air battery 1 of this embodiment may include a separator disposed between the positive electrode 13 and the negative electrode 12. Since the separator is disposed between the positive electrode 13 and the negative electrode 12, a highly safe battery can be obtained. The separator is not particularly limited as long as having a function to electrically separate the positive electrode layer 13a from the negative electrode layer 12a. As the separator, a porous insulating material may be used. As the porous insulating material, for example, a porous film, a resin-made non-woven cloth, a glass fiber-made non-woven cloth, or a paper-made non-woven cloth may be mentioned. As the porous film, for example, a polyethylene (PE) porous film or a polypropylene (PP) porous film may be mentioned. As the resin-made non-woven cloth, for example, a PE non-woven cloth or a PP non-woven cloth may be mentioned.

A porosity of the separator is, for example, in the range of 30% or more and 90% or less. When the porosity is in the range described above, a sufficient amount of the electrolyte is retained in the separator, and in addition, the separator has a sufficient strength. The porosity of the separator may also be in the range of 35% or more and 60% or less. The porosity is calculated from the true density, the total volume including the pores, and the weight of the material.

### 4. Electrolyte Layer

The electrolyte layer 14 is disposed between the negative electrode 12 and the positive electrode 13 and is a layer responsible for conduction of lithium ions. The electrolyte layer 14 is formed of a nonaqueous electrolyte and is provided between the negative electrode 12 and the positive electrode 13. The nonaqueous electrolyte is a lithium ion conductor having a lithium ion conductivity. The form of the electrolyte layer is not particularly limited. The electrolyte layer 14 may be formed of a liquid electrolyte, a solid electrolyte, or a gel electrolyte or may also be formed in combination therebetween. The electrolyte layer 14 may be formed of an organic solution containing a lithium salt or a high molecular weight solid electrolyte containing a lithium salt. The electrolyte layer 14 may have a membrane shape.

In one example, a nonaqueous electrolyte liquid prepared by dissolving a lithium salt in a nonaqueous solvent may be used as the electrolyte layer 14. The nonaqueous electrolyte liquid may be impregnated in the negative electrode 12 and/or in the positive electrode 13.

As the lithium salt dissolved in the nonaqueous electrolyte liquid, for example, lithium bis(trifluoromethanesulfonyl)imide (LIN(SO₃CF₃)₂), lithium perchlorate (LiClO₄), lithium hexafluorophosphate (LiPF₆), lithium tetrafluoroborate (LiBF₄), lithium trifluoromethanesulfonate (LiCF₃SO₃), or lithium bis(trifluoromethanesulfonyl)imide (LiN(CF₃SO₂)₂) may be mentioned but not limited thereto. As the electrolyte salt of the nonaqueous electrolyte liquid of the lithium air battery 1, a known lithium salt may be used.

A concentration of the electrolyte salt of the nonaqueous electrolyte liquid is, for example, 0.5 mol/litter or more and 2.5 mol/liter or less. When the nonaqueous electrolyte liquid is used as the electrolyte layer 14, the nonaqueous electrolyte liquid is impregnated and retained in the separator, so that the electrolyte layer 14 can be formed.

As the nonaqueous solvent of the nonaqueous electrolyte liquid of the lithium air battery 1, a known nonaqueous solvent may be used. As the nonaqueous solvent, for example, an ether or a carbonate may be mentioned.

As the nonaqueous solvent, an ether may be used. Compared to a carbonate, the ether is not likely to cause a side reaction other than a redox reaction of oxygen in the positive electrode 13. In other words, the ether has an excellent oxygen radical resistance. Hence, the ether is suitably used as the solvent of the nonaqueous electrolyte liquid of the lithium air battery 1. When an ether having a sufficient resistance against oxygen radicals generated in a discharge reaction is used as the solvent of the electrolyte liquid, a decomposed material of the electrolyte liquid can be suppressed from being deposited on the positive electrode 13 of the lithium air battery 1. Since an increase in resistance of the lithium air battery 1 can be suppressed, cycle characteristics of the lithium air battery 1 can also be improved.

The ether may be either a chain ether or a cyclic ether or may be a mixture thereof. Since being not likely to be vaporized and being particularly stable against oxygen radicals, the chain ether is suitable as the solvent of the electrolyte liquid of the lithium air battery 1. As the cyclic ether, for example, 2-methyltetrahydrofuran or tetrahydrofuran may be mentioned. As the chain ether, for example, a dialkyl ether, a symmetric glycol diether, or an asymmetric glycol diether may be mentioned. As the dialkyl ether, for example, dibutyl ether may be mentioned. The symmetric glycol diether may also be called a glyme. As the glyme, for example, monoglyme, diglyme, triglyme, tetraglyme, pentaglyme, or hexaglyme may be mentioned. In the nonaqueous electrolyte liquid, as the nonaqueous solvent, the ether may only be contained.

The glyme has an excellent oxygen radical resistance. Since the glyme is used as the solvent of the electrolyte liquid, the decomposition of the electrolyte liquid can be not only suppressed, but the increase in resistance of the lithium air battery 1 can also be suppressed. In the nonaqueous electrolyte liquid, as the nonaqueous solvent, the glyme may only be contained.

The glyme may be at least one selected from the group consisting of triglyme and tetraglyme. Triglyme and tetraglyme each have both a low volatility and a low viscosity. Since triglyme and/or tetraglyme is used as the solvent of the electrolyte liquid, while liquid shortage of the lithium air battery 1 is prevented, transport of lithium ions and oxygen can be smoothly performed, and the discharge capacity can be increased. In terms of the prevention of liquid shortage, tetraglyme is superior to triglyme. In terms of the transport of lithium ions and oxygen, triglyme is superior to tetraglyme.

The nonaqueous electrolyte liquid of the lithium air battery 1 according to this embodiment further contains, as an additive to improve the solubility of oxygen in the nonaqueous electrolyte liquid and the dissolution rate of oxygen in the nonaqueous electrolyte liquid, at least one selected from the group consisting of a fluorinated compound of an orthoester and a fluorinated compound of a boric acid ester. The fluorinated compound of an orthoester and the fluorinated compound of a boric acid ester are represented by the formula (1) and the formula (2), respectively.

In this specification, the compounds represented by the following formula (1) and formula (2) are each called the “compound A” in some cases.

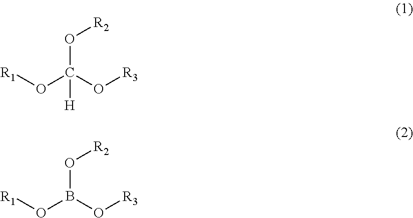

In the formula (1) and the formula (2), R₁, R₂, and R₃ each independently represent a fluorinated alkyl group having 1 to 5 carbon atoms.

Since a dipole moment and a polarizability of the compound A are small, an intermolecular interaction of the compound A is weak. When the intermolecular interaction is weak, a gas is likely to intrude between molecules. Hence, when the compound A is used as the solvent of the nonaqueous electrolyte liquid or is mixed with the nonaqueous electrolyte liquid, the solubility of oxygen and the dissolution rate of oxygen in the nonaqueous electrolyte liquid can be improved. As a result, the discharge capacity of the lithium air battery 1 can be increased.

The compound represented by the formula (1) or the formula (2) can be a partially fluorinated compound of an orthoester or a partially fluorinated compound of a boric acid ester, respectively. When at least one, but not all, hydrogen atom is only substituted by a fluorine atom, the compound A has an appropriately small polarizability. As a result, a sufficient amount of the compound A can be compatible with a nonaqueous solvent, and in addition, a sufficient amount of an electrolyte salt can be dissolved in a nonaqueous solvent.

For example, a compound in which all hydrogen atoms in its molecule are substituted by fluorine atoms, such as a perfluorocarbon, has a very small polarizability. When all hydrogen atoms are substituted by fluorine atoms, dissolution of an electrolyte salt in a nonaqueous solvent may be disturbed in some cases. In addition, since a perfluoroalkyl group decreases the compatibility of the compound A with a nonaqueous solvent, the probability of phase separation between the nonaqueous solvent and the compound A may also be increased. From this point of view, R₁, R₂, and R₃ in the formula (1) or the formula (2) each may independently represent a partially fluorinated alkyl group.

In the compound A, as the number of carbon atoms in its molecule is increased, the molecular weight thereof is also increased. As the molecular weight is increased, an amount of the compound A compatible with an ether tends to decrease. From this point of view, upper limits of the numbers of carbon atoms of R₁, R₂, and R₃ in the formula (1) or the formula (2) can be determined. The upper limits of the numbers of carbon atoms of R₁, R₂, and R₃ are each appropriately “five”, may be “four”, may also be “three”, and may further be “two”.

The nonaqueous electrolyte liquid may contain, as the compound represented by the formula (2) or the formula (1), at least one selected from the group consisting of tris(2,2,2-trifluoroethyl)borate (TFEB) and tris(2,2,2-trifluoroethyl)orthoformate (TFEO). TFEB and TFEO are examples of the compound A in which the numbers of carbon atoms of R₁, R₂, and R₃ of the formula (2) or the formula (1) are each three or less. Since the molecular weights of TFEB and TFEO are not excessively large, those compounds A each have a sufficient compatibility with a nonaqueous solvent. Hence, those compounds A can sufficiently improve the solubility of oxygen in the nonaqueous electrolyte liquid and the dissolution rate of oxygen in the nonaqueous electrolyte liquid.

The compound A is contained in the nonaqueous electrolyte liquid, for example, at a concentration of 0.1 percent by weight or more. An upper limit of the concentration is, for example, 99 percent by weight. When the compound A has a perfluoroalkyl group, since the polarizability of the compound A is small, the compatibility of the compound A with a nonaqueous solvent tends to be low. On the other hand, when at least one, but not all, hydrogen atom of the alkyl group is only substituted by a fluorine atom, that is, when R₁, R₂, and R₃ of the formula (1) or the formula (2) each have at least one hydrogen atom and at least one fluorine atom, the compound A has a sufficient compatibility with a nonaqueous solvent. As a result, the solubility of oxygen in the nonaqueous electrolyte liquid and the dissolution rate of oxygen in the nonaqueous electrolyte liquid can be sufficiently improved.

Besides a sufficient compatibility of the compound A with a nonaqueous solvent, dissolution of a lithium salt in a nonaqueous solvent containing the compound A at a sufficient concentration (such as 0.5 mol/l or more at 25° C.) is important. For example, in a nonaqueous solvent containing tetraglyme and TFEO in which a concentration of TFEO is 90 percent by weight, (LiN(SO₃CF₃)₂) which is a lithium salt can be dissolved at a concentration of 1.0 mol/l.

As other nonaqueous solvents which can be used for the nonaqueous electrolyte liquid, dimethylsulfoxide may be mentioned. The other nonaqueous solvents may include an ionic liquid, such as N-methyl-N-propylpiperidinium bis(trifluoromethanesulfonyl)imide.

The electrolyte layer 14 may contain an oxygen generation catalyst. In the nonaqueous electrolyte liquid, an oxygen generation catalyst may be contained. As the oxygen generation catalyst, a liquid phase catalyst called a redox mediator may be mentioned which is changed into a cationic body by oxidation performed on a surface of the positive electrode 13 in the charge and which promotes decomposition of lithium peroxide formed as a discharge product. As the redox mediator, for example, there may be mentioned tetrathiafulvalene, ferrocene, 2,2,6,6-tetramethylpiperidine-1-oxyl, 2-azaadamantane-N-oxyl, 9-azanoradamantane-N-oxyl, 1,5-dimethyl-9-azanoradamantane-N-oxyl, 9-azabicyclo[3.3.1]nonane-N-oxyl, 4-acetamide-2,2,6,6-tetramethylpiperidine-1-oxyl, lithium iodide, lithium bromide, 10-methylphenotiazine, N,N,N,N-tetramethyl-p-phenylenediamine, 5,10-dihydro-5,10-dimethylphenazine, tris[4-(diethylamino)phenyl]amine, or iron phthalocyanine. At least one selected from those compounds may be used as the oxygen generation catalyst.

### 5. Battery Case

As long as capable of receiving the positive electrode 13, the negative electrode 12, and the electrolyte layer 14 as described above, the battery case 11 of the lithium air battery 1 of this embodiment is not particularly limited in terms of the shape and the like. The shape of the battery case 11 of the lithium air battery 1 of this embodiment is not limited to that shown in FIG. 1, and various shapes, such as a coin shape, a flat plate shape, a cylindrical shape, and a laminate shape, may be used. The battery case 11 may be either an air open type battery case or an airtight type battery case. The air open type battery case has a ventilation hole through which air flows in and out and is a case in which air can be in contact with the positive electrode. In the case of the airtight type battery case, the airtight type battery case may be provided with a supply port and an emission port for a gas. In this case, the gas to be supplied and emitted may be a dry gas. The gas to be supplied and emitted may have a high oxygen concentration or may also be pure oxygen (oxygen concentration: 99.99%). In the discharge, the oxygen concentration may be high, and in the charge, the oxygen concentration may be low.

### EXAMPLES

Hereinafter, the present disclosure will be described in more detail with reference to examples. The following examples are described by way of example, and the present disclosure is not limited to the following examples.

### Example 1-1

As a carbon material, a Ketjen black powder (manufactured by Lion Corporation) was used. As a binder, a PTFE powder (manufactured by Daikin Industries, Ltd.) was used. The carbon material and the binder were mixed together at a mass ratio of 90:10 using an ethanol solvent, so that a mixture was obtained. The mixture was rolled by a roll press, so that an electrode sheet was formed. The electrode sheet thus obtained was cut, so that a positive electrode (positive electrode layer) was obtained.

LiN(SO₃CF₃)₂ (manufactured by Kishida Chemical Co., Ltd.) was mixed with and dissolved in tetraglyme (manufactured by Kishida Chemical Co., Ltd.) so as to have a concentration of 1 mol/l. TFEB was dissolved in the mixed solution so as to have a concentration of 5 percent by weight, so that a nonaqueous electrolyte liquid was obtained.

As a separator, a glass fiber-made separator was prepared. A SUS304 mesh (manufactured by The Nilaco Corporation) functioning as a collector was adhered to metal lithium foil (manufactured by The Honjo Chemical Corporation), so that a negative electrode was obtained. By using the positive electrode, the separator, the nonaqueous electrolyte liquid, and the negative electrode, a lithium air battery of Example 1-1 having the structure as shown in FIG. 1 was formed.

### Example 1-2

Except for that the concentration of TFEB in the nonaqueous electrolyte liquid was changed to 10 percent by weight, by the same method as that of Example 1-1, a lithium air battery of Example 1-2 was formed.

### Example 1-3

Except for that TFEO was used instead of using TFEB, by the same method as that of Example 1-2, a lithium air battery of Example 1-3 was formed. The concentration of TFEO in the nonaqueous electrolyte liquid was 10 percent by weight.

### Comparative Example 1-1

Except for that TFEB was not used, by the same method as that of Example 1-1, a lithium air battery of Comparative Example 1-1 was formed.

### Comparative Example 1-2

Except for that 1,1,1,2,2,3,3,4,4-nonafluoro-6-propoxyhexane was used instead of using TFEB, by the same method as that of Example 1-2, a lithium air battery of Comparative Example 1-2 was formed. The concentration of 1,1,1,2,2,3,3,4,4-nonafluoro-6-propoxyhexane in the nonaqueous electrolyte liquid was 10 percent by weight.

### Comparative Example 1-3

Except for that methyl nonafluorobutyl ether was used instead of using TFEB, by the same method as that of Example 1-2, a lithium air battery of Comparative Example 1-3 was formed. The concentration of methyl nonafluorobutyl ether in the nonaqueous electrolyte liquid was 10 percent by weight.

### Comparative Example 1-4

Except for that 1,2-(1,1,2,2-tetrafluoroethoxy)ethane was used instead of using TFEB, by the same method as that of Example 1-2, a lithium air battery of Comparative Example 1-4 was formed. The concentration of 1,2-(1,1,2,2-tetrafluoroethoxy)ethane in the nonaqueous electrolyte liquid ether was 10 percent by weight.

### Comparative Example 1-5

Except for that 1,1,2,2-tetrafluoroethyl 2,2,3,3-tetrafluoropropyl ether was used instead of using TFEB, by the same method as that of Example 1-2, a lithium air battery of Comparative Example 1-5 was formed. The concentration of 1,1,2,2-tetrafluoroethyl 2,2,3,3-tetrafluoropropyl ether in the nonaqueous electrolyte liquid was 10 percent by weight.

### [Discharge Test]

In an oxygen atmosphere, a discharge test was performed on the lithium air battery of each of those examples and comparative examples. A current density in the discharge was 0.4 mA/cm², and a cut-off voltage was 2.0 V. Discharge curves of the lithium air batteries formed in those examples and comparative examples were obtained under the discharge conditions described above and are shown in FIG. 2. In addition, the discharge capacities of the lithium air batteries formed in those examples and comparative examples are shown in Table 1.

TABLE 1

| | DISCHARGE CAPACITY |
|---|---|
| | (mAh) |
| EXAMPLE 1-1 | 12.7 |
| EXAMPLE 1-2 | 17.7 |
| EXAMPLE 1-3 | 6.7 |
| COMPARATIVE EXAMPLE 1-1 | 4.9 |
| COMPARATIVE EXAMPLE 1-2 | 5.5 |
| COMPARATIVE EXAMPLE 1-3 | 5.2 |
| COMPARATIVE EXAMPLE 1-4 | 5.0 |
| COMPARATIVE EXAMPLE 1-5 | 5.6 |

As shown in FIG. 2, the lithium air battery of each example in which the nonaqueous electrolyte liquid containing TFEB or TFEO was used had a high discharge capacity. When Example 1-1 and Example 1-2 are compared to each other, the lithium air battery of Example 1-2 had a higher discharge capacity. It is believed that as the concentration of TFEB is increased, the solubility of oxygen in the nonaqueous electrolyte liquid and the dissolution rate of oxygen in the nonaqueous electrolyte liquid are increased, and as a result, the discharge capacity is increased.

The discharge capacity of the lithium air battery of Example 1-3 in which TFEO was used was smaller than the discharge capacity of the lithium air battery of each of Examples 1-1 and 1-2 using TFEB. To the carbon which is the center atom of TFEO, besides three oxygen atoms, one hydrogen atom is also bonded, and hence, the symmetry of the TFEO molecule is lower than that of the TFEB molecule. Hence, the polarizability of TFEB is lower than that of TFEO. In view of the effect of improving the solubility of oxygen and the dissolution rate of oxygen, TFEB is superior. However, TFEO has an advantage to be easily compatible with various types of solvents. When TFEB and TFEO are used in combination, it is believed that a lithium air battery having a discharge capacity between the discharge capacity of Example 1-2 and the discharge capacity of Example 1-3 can be obtained.

By using an atmosphere switching potentiostatic test, an oxygen solubility of the electrolyte liquid can be evaluated. In particular, from the magnitude of a current flowing upon application of an oxygen reducing potential to the electrolyte liquid, the oxygen solubility is evaluated. After the oxygen reducing potential was applied for 100 seconds to an electrolyte liquid processed by a de-oxidation treatment in advance, oxygen introduction into the electrolyte liquid is started, and a current value is measured further for 100 seconds.

### Example 2-1

TBATFSI (CH₃CH₂CH₂CH₂)₄N[N(SO₂CF₃)₂] (manufactured by Aldrich) was mixed with and dissolved in tetraglyme (manufactured by Kishida Chemical Co., Ltd.) to have a concentration of 0.1 mol/l. In this mixed solution, TFEB was dissolved to have a concentration of 10 percent by weight, so that a nonaqueous electrolyte liquid was obtained. In order to suppress generation of lithium peroxide and deposition thereof on a working electrode when the oxygen reducing potential was applied, a supporting salt containing no lithium salt was used.

An electrochemical-measurement airtight container which had a gas inlet port and a gas outlet port and which could perform a gas exchange was prepared, and in this electrochemical-measurement airtight container, the nonaqueous electrolyte liquid prepared by the method described above was received, and after an argon purge was performed in the electrolyte liquid and the container, the container was tightly sealed. Subsequently, after the oxygen reducing potential (2.2 V vs. Li/Li⁺) was applied for 100 seconds, the gas inlet port was opened to introduce pure oxygen, and by further applying the potential for 100 seconds, the current value was measured.

### Example 2-2

Except for that TFEO was used instead of using TFEB, by the same method as that of Example 2-1, the atmosphere switching potentiostatic test was performed. The concentration of TFEO in the mixed solution was 10 percent by weight.

### Comparative Example 2-1

Except for that TFEB was not used, by the same method as that of Example 2-1, the atmosphere switching potentiostatic test was performed.

### Comparative Example 2-2

Except for that 1,1,1,2,2,3,3,4,4-nonafluoro-6-propoxyhexane was used instead of using TFEB, by the same method as that of Example 2-1, the atmosphere switching potentiostatic test was performed. The concentration of 1,1,1,2,2,3,3,4,4-nonafluoro-6-propoxyhexane in the mixed solution was 10 percent by weight.

### Comparative Example 2-3

Except for that methyl nonafluorobutyl ether was used instead of using TFEB, by the same method as that of Example 2-1, the atmosphere switching potentiostatic test was performed. The concentration of methyl nonafluorobutyl ether in the mixed solution was 10 percent by weight.

### Comparative Example 2-4

Except for that 1,2-(1,1,2,2-tetrafluoroethoxy)ethane was used instead of using TFEB, by the same method as that of Example 2-1, the atmosphere switching potentiostatic test was performed. The concentration of 1,2-(1,1,2,2-tetrafluoroethoxy)ethane in the mixed solution was 10 percent by weight.

### Comparative Example 2-5

Except for that 1,1,2,2-tetrafluoroethyl 2,2,3,3-tetrafluoropropyl ether was used instead of using TFEB, by the same method as that of Example 2-1, the atmosphere switching potentiostatic test was performed. The concentration of 1,1,2,2-tetrafluoroethyl 2,2,3,3-tetrafluoropropyl ether in the mixed solution was 10 percent by weight.

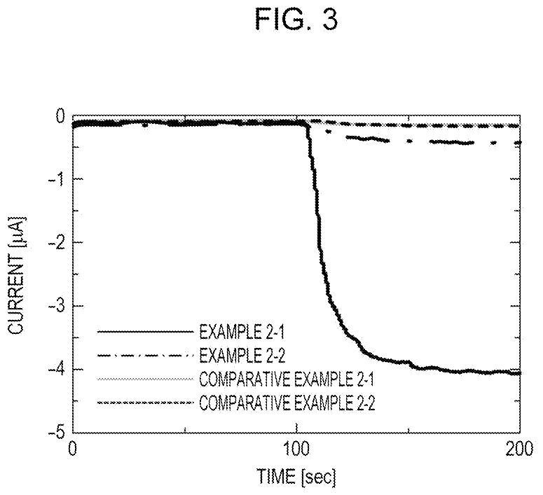

The changes in oxygen reducing current with time by the atmosphere switching potentiostatic test obtained in Examples 2-1 and 2-2 and Comparative Examples 2-1 and 2-2 are shown in FIG. 3. In addition, the oxygen reducing current values measured 200 seconds after the start of the atmosphere switching potentiostatic test of Examples 2-1 and 2-2 and Comparative Examples 2-1, 2-2, 2-3, 2-4, and 2-5 are shown in Table 2.

TABLE 2

| | OXYGEN REDUCING CURRENT |
|---|---|
| | (μA) |
| EXAMPLE 2-1 | 4.01 |
| EXAMPLE 2-2 | 0.43 |
| COMPARATIVE EXAMPLE 2-1 | 0.14 |
| COMPARATIVE EXAMPLE 2-2 | 0.16 |
| COMPARATIVE EXAMPLE 2-3 | 0.16 |
| COMPARATIVE EXAMPLE 2-4 | 0.14 |
| COMPARATIVE EXAMPLE 2-5 | 0.17 |

As shown in FIG. 3, according to all the electrolyte liquids used in Examples and Comparative Examples, the current value flowing upon the application of the oxygen reducing potential to the electrolyte liquid processed by the de-oxidation treatment was small. From the results thus obtained, it was understood that for example, no decomposition of materials in the electrolyte liquid occurs by the application of the oxygen reducing potential, and oxygen only generates a reducing current.

As shown in Table 2, compared to the nonaqueous electrolyte liquid containing a fluorinated compound, such as 1,1,1,2,2,3,3,4,4-nonafluoro-6-propoxyhexane (Comparative Example 2-2), methyl nonafluorobutyl ether (Comparative Example 2-3), or 1,1,2,2-tetrafluoroethyl 2,2,3,3-tetrafluoropropyl ether (Comparative Example 2-5), and the nonaqueous electrolyte liquid containing no additives (Comparative Example 2-1), the nonaqueous electrolyte liquids of Examples 2-1 and 2-2 containing TFEB and TFEO, respectively, each have a higher oxygen reducing current value; hence it is indicated that the nonaqueous electrolyte liquids of Examples 2-1 and 2-2 each have a high oxygen solubility.

That is, since the nonaqueous electrolyte liquid of Example 2-1 or 2-2 contains TFEB or TFEO, respectively, in the electrolyte liquid, the solubility of oxygen is believed to be increased. As a result, production of a lithium oxide (Li₂O₂) is promoted on the positive electrode in the discharge, and hence, the discharge capacity is believed to be increased.

According to the technique of the present disclosure, the discharge capacity of the lithium air battery can be increased. The lithium air battery of the present disclosure is useful as a secondary battery.

What is claimed is:

1. A lithium air battery comprising:
a negative electrode including a negative electrode collector and a negative electrode layer on the negative electrode collector, the negative electrode layer being made of lithium metal;
a positive electrode including an electrically conductive porous body containing carbon; and
an electrolyte provided between the negative electrode and the positive electrode, the electrolyte containing a compound represented by the following formula (1) or formula (2): 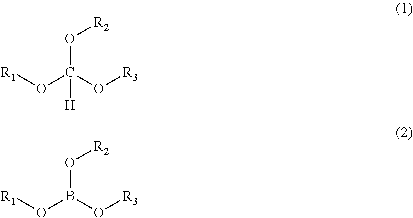
where in the formula (1) or the formula (2), R₁, R₂, and R₃ each independently represent a fluorinated alkyl group having 1 to 5 carbon atoms.

2. The lithium air battery according to claim 1,
wherein the compound includes at least one selected from the group consisting of tris(2,2,2-trifloroethyl)borate and tris(2,2,2-trifluoroethyl)orthoformate.

3. The lithium air battery according to claim 1,
wherein the electrolyte contains an ether.

4. The lithium air battery according to claim 3,
wherein the ether includes a chain ether.

5. The lithium air battery according to claim 4,
wherein the chain ether includes a glyme.

6. The lithium air battery according to claim 5,
wherein the glyme includes at least one selected from the group consisting of triglyme and tetraglyme.
